(19) United States
(12) Patent Application Publication
(10) Pub. No.: US 2007/0273970 A1
(43) Pub. Date: Nov. 29, 2007

(54) Wide field of view, compact collimating apparatus

(75) Inventors: Michael J. Hoppe, Vista, CA (US); Jerome T. Carollo, Carlsbad, CA (US)

Correspondence Address: VIERRA MAGEN MARCUS & DENIRO LLP, 575 MARKET STREET SUITE 2500, SAN FRANCISCO, CA, 94105, US

(73) Assignee: Creative display Systems, LLC

(21) Appl. No.: 11/442,571

(22) Filed: May 26, 2006

(51) Int. Cl. G02B 27/28

(52) U.S. Cl. 359/501; 359/483

(57) ABSTRACT

A compact, lightweight, multi-wavelength display system which can be used as a collimating eyepiece. A first polarization selective optical element reflects light have one linear polarization state while transmitting light having the orthogonal linear polarization state. A first quarter-wave plate transforms the linearly polarized light to a circular polarization. A combining optical element with a partially reflective surface reflects a portion of the transformed light and transmits a portion of the transformed light. A second quarter-wave plate transforms the circularly polarized light back to a linear polarization. A second polarization selective optical element reflects light have one linear polarization state while transmitting light having the orthogonal linear polarization state.

### TECHNICAL FIELD

The present invention relates generally to visual display systems and, more particularly, to a compact, collimating system that utilizes polarization selective optical elements to provide an increased field of view and a larger back focal length.

### BACKGROUND

Optical collimating apparatus have been known for some time. For example, U.S. Pat. No. 4,704,010 discloses a device capable of generating an optical collimating beam using a single, plano-convex lens. A collimating mark is applied on the convex surface and a reflective coating is applied to the central portion of the plano surface. Light emanating from the collimating mark makes a double pass through the lens, exiting the piano surface as a collimated beam. The collimating mark is imaged at infinity. In a specific embodiment, the collimating mark is illuminated using a prism.

U.S. Pat. No. 4,859,031 discloses an optical collimating device using a semi-reflective concave mirror and a cholesteric liquid crystal element. In at least one of the disclosed embodiments, the collimator is used in conjunction with a combiner, thus allowing the system to be used in a heads-up display device. Images in the line of sight of the viewer substantially pass through the combiner, semi-reflective mirror, and cholesteric liquid crystal to the viewer. Images generated by a source are reflected by the combiner into the line of sight of the viewer. The generated images pass through the semi-reflective mirror to the cholesteric liquid crystal element. The cholesteric element reflects the images back to the concave side of the semi-reflective mirror. The concave mirror creates an image of the source at the same time it reverses the polarization of the image, thus allowing it to pass through the cholesteric element to the viewer.

U.S. Pat. No. 5,408,346 discloses an optical collimating device using a cholesteric liquid crystal element, the device exhibiting improved image transmissivity. Both reflective and transmissive systems are disclosed. The patent also discloses the use of the collimator in conjunction with a combiner, thus allowing multiple images to be superimposed for viewing by the user.

U.S. Pat. No. 5,715,023 discloses a compact display system that can be used as a collimating eyepiece. The system uses a cholesteric liquid crystal element in combination with an optical doublet. A partially reflective coating is at the interface between the two singlets which comprise the doublet. The design of this system reduces the number of element to air and/or element to element interfaces, thus reducing losses and ghosting while making a sturdy, vibration tolerant display system. In one embodiment of the disclosed system, multiple cholesteric liquid crystal elements are used, thus achieving a multicolor display system.

U.S. Pat. No. 6,075,651 discloses a compact, lightweight, multi-wavelength display system which can be used as a collimating eyepiece. The system utilizes a polarization selective optical element that reflects one linear polarization state while transmitting radiation of the orthogonal linear polarization state. The polarization selective optical element is used in combination with a quarter wave plate and an optical element, the optical element including a partially reflective surface. The optical element may either be a single element or an optical doublet. In the latter configuration, the partially reflective surface is at the interface between the two singlets that comprise the doublet.

From the foregoing, it remain desirable to have a compact, collimating eyepiece that is capable of providing a wide field of view over a wide range of wavelengths, and a larger back focal length for a given object source. Such a device is of particular interest in the area of head-mounted displays.

### SUMMARY

The present disclosure describes a compact, lightweight, multi-wavelength display system which can be used as a collimating eyepiece. In the preferred embodiment, the collimating apparatus includes a combiner element with a partially reflective surface and polarizers positioned on both sides of the combiner element, wherein the polarizers include a polarization selective optical element that reflects light have one linear polarization state while transmitting light having the orthogonal linear polarization state. A quarter-wave plate is positioned adjacent to the polarization selective optical element to transform linearly polarized light to circularly polarized light on one side of the combiner, then back the other way on the other side of the combiner.

The reflective surface on the combiner element may be formed by depositing a dielectric coating on the powered surface. Preferably, the coating has a transmittance of approximately 50% and a reflectance of approximately 50%. Further, the combiner element is preferably a concave lens with the concave surface facing the image source.

A further understanding of the nature and advantages of the present invention may be realized by reference to the remaining portions of the specification and the drawings.

### BRIEF DESCRIPTION OF THE DRAWINGS

FIG. 1 is a plan view illustrating a preferred embodiment of a collimating device.

FIG. 2 is a plan view illustrating an alternative embodiment having a longer back focal length.

FIG. 3 is a plan view illustrating an alternative embodiment having a filled combiner lens.

FIG. 4 is a plan view illustrating another alternative embodiment having a filled combiner lens with no air spaces.

FIG. 5 is a plan view illustrating the device of FIG. 4 utilized with a cube for multi-display configurations.

FIG. 6 is a plan view illustrating another alternative embodiment having a button lens for increased performance.

FIG. 6 is a plan view illustrating another alternative embodiment having a curved analyzer portion.

### DETAILED DESCRIPTION OF SPECIFIC EMBODIMENTS

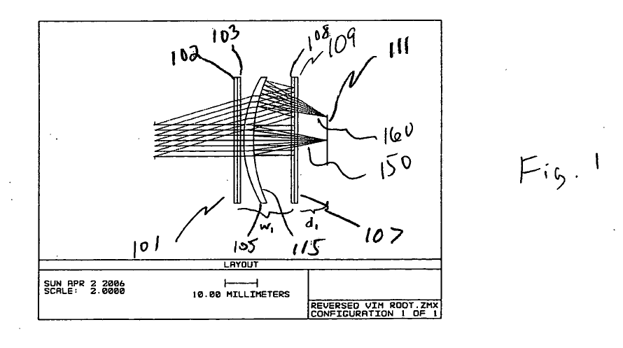

Referring now to FIG. 1, a preferred embodiment of the invention is illustrated in which a collimating apparatus 100 is located proximate to an image source 111. The collimating apparatus 100 includes a combining optical element 105 positioned between two polarizing assemblies 101, 107. Preferably, the combining element 105 is a simple concave lens with the curvature of the lens dictated by the size of the image source 111. The powered concave surface 106 of the lens 105 faces the image source 111. Further, the powered surface 106 has a partially reflective coating 115 formed thereon. Preferably, coating 115 is a dielectric coating with a transmittance of approximately 50 percent and a reflectance of approximately 50 percent in the wavelength range of interest.

Advantageously, each of the polarizing assemblies includes a polarization selective optical element (“PS element”) that reflects radiation having one polarization state while transmitting radiation having the orthogonal polarization state. For example, a preferred PS element is the ProFlux™ polarizer manufactured by Moxtek, Inc., which includes a thin layer of aluminum ribs formed onto a glass substrate. An alternative is provided by using a thin film material, such as the Dual Brightness Enhancement Film (“DBEF”) made by 3M®. Such material can be designed to efficiently reflect electromagnetic radiation in a broad band of wavelengths, for example visible light, that has a particular plane, or linear, polarization while transmitting light of an orthogonal polarization. For example, a PS element can be designed to reflect p-polarized visible light while transmitting s-polarized light. The PS element does not alter either the polarization of the transmitted light or the polarization of the reflected light.

In the present embodiment, the polarizing assembly 101 includes a PS optical element 102 juxtaposed with a quarter-wave plate 103. Likewise, the polarizing assembly 107 includes a PS optical element 109 juxtaposed with a quarter-wave plate 108. The quarter-wave plates permit appropriate transformations between linear polarization and circular polarization, while the PS elements reflect linearly polarized light having one polarization state and transmits linearly polarized light having the orthogonal polarization state.

In this embodiment, the total width w₁ of the collimating apparatus 100 is approximately 20 mm, with the image source 111 located at a distance d₁ approximately 10 mm behind the device.

Image source 111 typically transmits linearly polarized light, and therefore may include polarizer sheets 117 for that purpose, such as Q-12 polarizing optical film made by Nitto Denko Corp., or UHC-125U transmissive polarizer made by Polatechno Co., Ltd. Thus, an image comprised of p-linear polarized light is transmitted into the collimating apparatus 100.

The operation of the collimating apparatus will be explained with reference to two image rays 150, 160. Image ray 150 is representative of a point of light emanating from the center of the image source and directed toward the center of the collimating apparatus. Image ray 160 is representative of a point of light emanating from near the top of the image source and therefore directed at a sharper angle toward the top portion of the collimating apparatus.

Image ray 150 is transmitted by the image source 111 through polarizers 117 toward the collimating apparatus 100 as linear polarized light. The p-linear polarized light passes through the PS element 109 (s-polarized light is reflected), and quarter-wave plate 108 operates to transform the ray into right-handed circularly polarized (“RCP”) light. Upon hitting the partially reflective coating 115, some of the light is reflected back toward polarizing assembly 107 while the rest of the light is passed through the combiner element 105. The reflected light reverses sense to become left-handed circularly polarized (“LCP”) light, but upon passing through the quarter-wave plate 108, the LCP light is transformed back to a linear polarization state, and the PS element 109 thus now reflects the s-linear component back through the quarter-wave plate 108, where it regains its character as LCP light. As before, the surface coating 115 continues to reflect a portion and pass a portion of the light rays. The radiation that passes through the combiner element then hits the polarizing assembly 101. By passing through quarter-wave plate 103, the ray is transformed from a circular polarization to a linear polarization, and then upon hitting the PS element 102, s-linear polarized light is passed through the device.

A second image ray 160 is not transmitted along the viewing axis like ray 150, but is transmitted at some angle to the viewing axis. However, the same basic functional operation ensues. The ray 160 transmitted by the image source 111 through polarizers 117 consists of linear polarized light. The p-linear component passes through PS element 109, and quarter-wave plate 108 operates to transform the ray into RCP light. Upon hitting the partially reflective coating 115, some of the light is reflected back toward polarizing assembly 107 while the rest of the light is passed through the combiner element 105, but with some angle of refraction. The reflected light reverses sense to become LCP light, but upon passing back through the quarter-wave plate 108, the LCP light is transformed back to a linear polarization state, and the PS element 109 reflects the s-linear component back through the quarter-wave plate 108, where it regains its character as LCP light. The surface coating 115 continues to reflect a portion and pass a portion of the light rays. The radiation that passes (refracts) through the combiner element then hits the polarizing assembly 101. By passing through quarter-wave plate 103, the ray is transformed from a circular polarization to a linear polarization, and upon hitting the PS element 102, s-linear polarized light is passed through the device.

Although the described embodiment creates left-handed then right-handed circularly polarized light inside the collimating device, other orientations could be used. For example, the orientation could be reversed such that the light rays inside the collimating device are initially right-handed then left-handed circularly polarized light.

Advantageously, the field of view using the inventive collimating apparatus is larger by at least 10-20% than that of similar devices.

The preferred collimating apparatus 100 has the capability for broad-band imaging, thus enabling it to be used as a compact, multi-color (i.e., multi-wavelength) collimating system. The primary limitation to this broad-band capability (other than for the output of the source) is that imposed by the wavelength dependence of the reflective coating, and to address this issue, a broad-band reflective coating is preferably used. Such coatings are well known by those of skill in the art and therefore will not be described in detail in this specification.

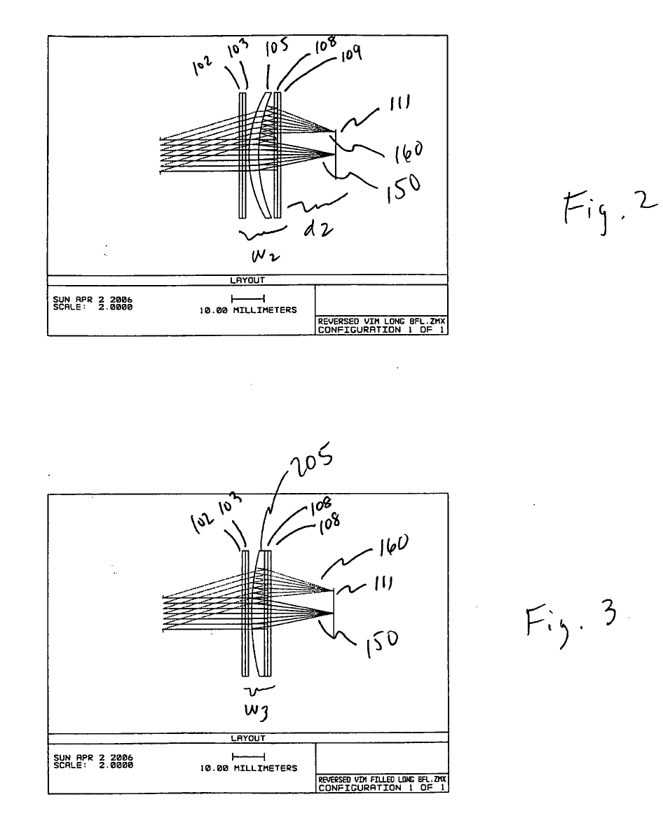

FIG. 2 illustrates an alternate embodiment of the invention. This embodiment includes all the same components as in the first embodiment. However, in this embodiment, the back focal length is increased by decreasing the space between components. For example, the total width w₂ of the collimating apparatus can collapsed as much as possible to approximately 12 mm, and the image source 111 may then be located further behind the device. In the illustrated embodiment, the image source is located at a distance d₂ of approximately 18 mm behind the device.

FIG. 3 illustrates another alternate embodiment of the invention. This embodiment still includes the polarizing assemblies 101, 107, but the system can be made with a filled combiner element 205, i.e., a plano-concave lens. In this configuration, the total width w₃ of the collimating apparatus can be reduced to less than 10 mm.

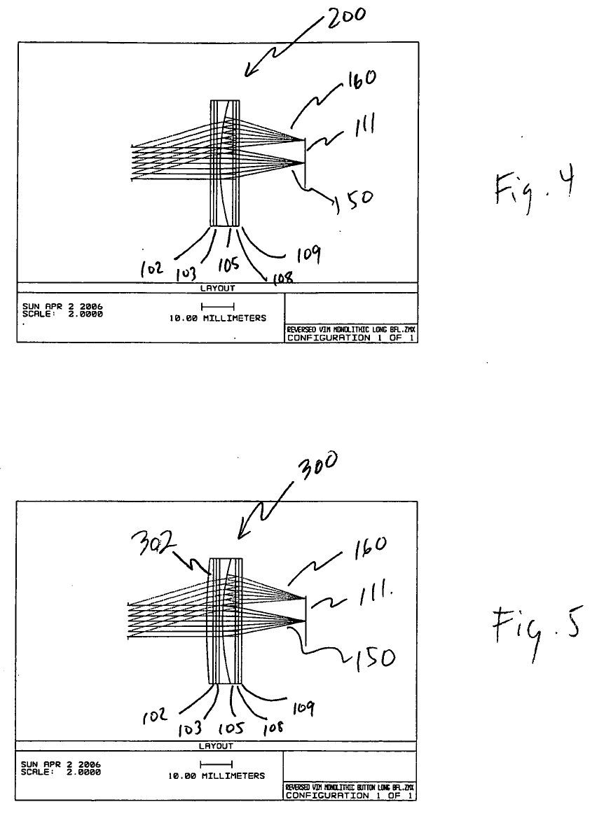

FIG. 4 illustrates yet another alternate embodiment that is a variation on the system of FIG. 3 which uses the monolithic lens approach, but in this embodiment, the collimating apparatus 200 is a sealed assembly with no air spaces between the components.

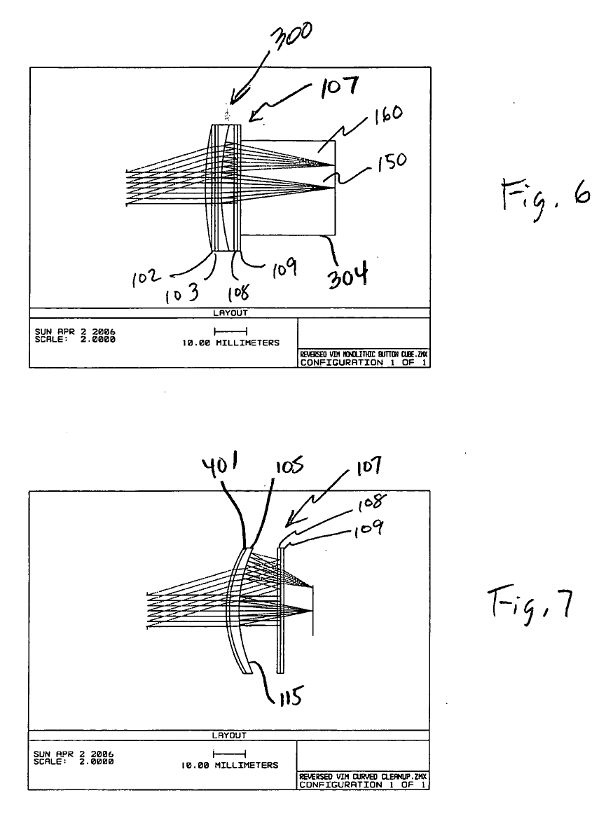

FIG. 5 illustrates an alternate embodiment that is a variation on the system of FIG. 4, wherein a button lens 302 is fixed in juxtaposition to the front of the polarizing assembly 101. The addition of button lens 302 provides increased performance of the collimating apparatus 300.

FIG. 6 illustrates an alternate embodiment that is a variation on the system of FIG. 5, wherein a cube 304 is fixed in juxtaposition to the rear of the polarizing assembly 107. This allows the collimating apparatus 300 to be used with multi-display configurations.

FIG. 7 illustrates another embodiment of the invention. This embodiment includes polarization assembly 107 and combiner element 105 having a partially reflective coating 115, but the polarization assembly 101 is replaced by polarization assembly 401, which is curved to follow the curvature of the lens 105.

In general, those skilled in the art to which this invention pertains will recognize that many changes in construction and widely differing embodiments will suggest themselves without departing from the spirit and essential characteristics of the invention. For example, the curvature of the combiner lens 105 may be varied in order to impart different optical powers to the system. Further, depending upon the desired application, the spacing between components may be adjusted. Further still, the reflective coating need not be a 50/50 dielectric coating, but could have other characteristics, including a different dielectric ratio, and the reflectivity could also be provided through the use of a partial metal mirror rather than a dielectric coating. More significantly, the image source may transmit other types of polarized light than described herein, and the system can be modified accordingly so that the PS element will reflect the particular polarization of light that is passed through the quarter-wave plate.

Accordingly, the disclosures and descriptions herein are intended to be illustrative only, and not limiting. The scope of the invention is set forth in the claims.

We claim:

1. An optical collimating apparatus useful for focusing an image transmitted by an image source at a desired distance as viewed by an observer, the apparatus comprising:
a combining optical element having a powered, partially reflective surface facing the image source;
a first polarizer positioned on one side of the combining element including a first polarization selective element; and
a second polarizer positioned on another side of the combining element including a second polarization selective element;
wherein each of the first and second polarization selective elements substantially reflects light having a first polarization state and substantially transmits light having a second polarization state which is orthogonal to the first polarization state.

2. An optical collimating apparatus as in claim 1, wherein the reflective surface is formed by depositing a reflective coating on the powered surface of the combining optical element.

3. An optical collimating apparatus as in claim 2, wherein the reflective coating is a dielectric coating.

4. An optical collimating apparatus as in claim 3, wherein the dielectric coating has a transmittance of approximately 50% and a reflectance of approximately 50%.

5. An optical collimating apparatus as in claim 1, wherein the combining element is a concave lens having a concave surface facing the image source.

6. An optical collimating apparatus as in claim 1, wherein the first polarizer includes a first quarter-wave plate held in juxtaposition with the first polarization selective element, and wherein the second polarizer includes a second quarter-wave plate held in juxtaposition with the second polarization selective element.

7. An optical collimating apparatus as in claim 6, wherein the first and second quarter-wave plates are positioned adjacent to the combining element.

8. An optical collimating apparatus as in claim 1, wherein the combining element and the first and second polarizers are arranged in close proximity with each other.

9. An optical collimating apparatus as in claim 1, wherein the second polarizer is positioned nearest the observer, further comprising a button lens fixed in juxtaposition with the second polarizer.

10. An optical collimating apparatus as in claim 1, wherein the first polarizer is positioned nearest the image source, further comprising a cube fixed in juxtaposition with the first polarizer.

11. An optical collimating apparatus as in claim 1, wherein the second polarizer is positioned nearest the observer, and wherein the second polarizer has the same shape as the combiner element and is placed in juxtaposition with the second polarizer.

12. An optical collimating apparatus useful for focusing an image transmitted by an image source at a desired distance as viewed by an observer, the apparatus comprising:
a concave lens having a partially reflective concave surface, wherein the concave surface faces the image source;
a first polarizer positioned on one side of the lens and including a first polarization selective element; and
a second polarizer positioned on another side of the lens and including a second polarization selective element;
wherein each of the first and second polarization selective elements substantially reflects light having a first polarization state and substantially transmits light having a second polarization state, wherein the second polarization state is orthogonal to the first polarization state.

13. An optical collimating apparatus as in claim 12, wherein the reflective surface is formed by depositing a reflective coating on the powered surface of the combining optical element.

14. An optical collimating apparatus as in claim 13, wherein the reflective coating is a dielectric coating.

15. An optical collimating apparatus as in claim 14, wherein the dielectric coating has a transmittance of approximately 50% and a reflectance of approximately 50%.

16. An optical collimating apparatus as in claim 12, wherein the first polarizer includes a first quarter-wave plate held in juxtaposition with the first polarization selective element, and wherein the second polarizer includes a second quarter-wave plate held in juxtaposition with the second polarization selective element.

17. An optical collimating apparatus as in claim 16, wherein the first and second quarter-wave plates are positioned adjacent to the combining element.

18. An optical collimating apparatus as in claim 12, wherein the combining element and the first and second polarizers are arranged in close proximity with each other.

19. An optical collimating apparatus as in claim 12, wherein the second polarizer is positioned nearest the observer, further comprising a button lens fixed in juxtaposition with the second polarizer.

20. An optical collimating apparatus as in claim 12, wherein the first polarizer is positioned nearest the image source, further comprising a cube fixed in juxtaposition with the first polarizer.

21. An optical collimating apparatus as in claim 12, wherein the second polarizer is positioned nearest the observer, and wherein the second polarizer has the same shape as the combiner element and is placed in juxtaposition with the second polarizer.

22. A method for optically collimating an image at a desired distance from an observer, comprising the steps of:
directing a light ray from an image source toward a collimating apparatus;
reflecting a first portion of the light ray having a first linear polarization state and transmitting a second portion of the light ray having a second linear polarization state, wherein the second linear polarization state is orthogonal to the first linear polarization state;
transforming the polarization of the second portion of the light ray from the second linear polarization to a circular polarization;
reflecting a first portion of the circularly polarized transformed light ray and transmitting a second portion of the circularly polarized transformed light ray;
transforming the polarization of the second portion of the transformed light ray from the circular polarization to the second linear polarization; and
reflecting a first portion of the linearly polarized transformed light ray having the first polarization state and transmitting a second portion of the linearly polarized transformed light ray having the second polarization state.
